(19) United States
(12) Patent Application Publication
(10) Pub. No.: US 2006/0266770 A1
(43) Pub. Date: Nov. 30, 2006

(54) Portable dispensers comprising a mobile dispenser and mobile storage cartridge

(76) Inventor: Robert M. Fitzgerald, Norcross, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/138,817

(22) Filed: May 26, 2005

(51) Int. Cl. B67D 5/52

(52) U.S. Cl. 222/137

(57) ABSTRACT

A dispenser for dispensing articles such as hospital bed linens or garments. In various embodiments, the dispenser includes a wheeled storage cartridge defining an interior portion for receiving items to be distributed from the dispenser and a wheeled dispenser portion defined by a control system and one or more access doors. The storage cartridge and dispenser portion are configured to operatively engage each other so that an open face of the storage cartridge is aligned with the access doors of the dispenser portion. When in a first, closed position, the access doors are configured to prevent unauthorized access to the articles stored within the storage cartridge. The access doors may be moved into a second, open position to allow a user access to the interior portion of the storage cartridge. Access to the storage cartridge may be controlled by a control system associated with the dispenser portion.

### BACKGROUND OF THE INVENTION

Currently, when changing bed linens within a hospital, a nurse typically loads a hospital cart with a load of bed linens and then wheels the cart to a first patient room. The nurse then parks the cart outside the first room, removes the needed bed linens from the cart, enters the room, and changes the linens. The nurse then wheels the cart to a next patient room and repeats the process described above.

While the nurse is in a particular patient's room, the nurse typically leaves their linen cart unattended outside the room. While the cart is unattended, linens are often removed from the cart by other members of the hospital staff, patients, or other visitors who may then remove the linens from the hospital. This can cost hospitals a significant amount of money every year.

Accordingly, there is a need for an improved system for distributing linens and other items, especially within the context of a hospital environment.

### BRIEF SUMMARY OF THE INVENTION

A mobile dispenser according to one embodiment of the invention comprises: (1) a storage cartridge defining an interior portion that is adapted for receiving one or more items to be dispensed from the mobile dispenser, the storage cartridge being mounted adjacent a first set of one or more rolling mechanisms so that the storage cartridge may be rolled adjacent a support surface; and (2) a dispenser portion that is adapted to be selectively attached adjacent the storage cartridge, the dispenser portion being mounted adjacent a second set of one or more rolling mechanisms so that the dispenser portion may be rolled adjacent the support surface. In this embodiment, the dispenser portion is adapted to selectively prevent access to the one or more items when: (A) the one or more items are disposed within the interior portion at the storage cartridge; and (B) the dispenser portion is attached adjacent the storage cartridge.

A mobile dispenser according to a further embodiment of the invention comprises: (1) a storage cartridge defining an interior portion that is adapted for receiving one or more items to be dispensed from the mobile dispenser, the storage cartridge being mounted adjacent a first set of one or more rolling mechanisms so that the storage cartridge may be rolled adjacent a support surface; (2) a dispenser portion that is adapted to be selectively attached adjacent the storage cartridge to form a mobile dispensing apparatus. In this embodiment, when the dispenser portion is attached adjacent the storage cartridge to form the mobile dispensing apparatus: (A) the dispenser portion is supported by the storage cartridge, and (B) both the storage cartridge and the dispenser portion are rollably supported by the one or more rolling mechanisms.

In various embodiments of the invention, the mobile dispenser comprises a dispenser portion that includes a door portion that is configured to selectively prevent access to the one or more items through an access opening defined by the dispenser portion when: (A) the one or more items are disposed within the storage cartridge's interior portion; and (B) the dispenser portion is attached adjacent the storage cartridge. In certain embodiments, the dispenser portion is adapted to selectively prevent access to the one or more items by: (A) receiving authorization information from a user; (B) determining whether the authorization information is valid; (C) in response to determining that the authorization information is valid, unlocking the door portion to permit access to the one or more items through the access opening; and (D) in response to determining that the authorization is not valid, maintaining the door portion in a locked configuration so that the door portion prevents access to the one or more items through the access opening.

A method of dispensing items according to a particular embodiment of the invention comprises: (A) providing a wheeled cart defining an interior portion that is dimensioned for receiving one or more items to be dispensed from the wheeled cart; (B) providing a wheeled, automated dispenser portion that is adapted to be attached adjacent the wheeled cart, and to selectively prevent access to the interior portion of the wheeled cart when the automated dispenser portion is attached adjacent the wheeled cart; (C) attaching the automated dispenser portion adjacent the wheeled cart; and (D) using the automated dispenser portion to selectively prevent access to one or more items stored within the interior portion of the wheeled cart.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a top view of a dispenser according to one embodiment of the present invention. In this figure, the dispenser's storage cartridge is shown attached adjacent the dispenser's dispenser portion.

FIG. 2 is a perspective view of the dispenser portion shown in FIG. 1.

FIG. 3 is a perspective view of the storage cartridge shown in FIG. 1.

FIG. 4 is a perspective view of the storage cartridge and dispenser portion shown in FIG. 1. The arrow indicates that the storage cartridge is being moved toward the dispenser portion.

FIG. 5 is a perspective view of the dispenser of FIG. 1. This figure shows the storage cartridge attached adjacent the dispenser portion. In this figure, the dispenser portion's lower door is shown closed, and the dispenser portion's upper door is shown partially open.

FIG. 6 is a front view of the dispenser of FIG. 5. This figure shows the dispenser's storage cartridge attached adjacent a corresponding dispenser portion. In this figure, the dispenser portion's lower door is shown closed, and the dispenser portion's upper door is shown partially open.

FIG. 7 is a top view of the storage cartridge shown in FIG. 3.

FIG. 8 is a front view of the storage cartridge shown in FIG. 3.

FIG. 9 is a top view of the dispenser portion shown in FIG. 2.

FIG. 10 is a side view of the dispenser portion shown in FIG. 2.

FIG. 11 is a front view of the dispenser portion shown in FIG. 2.

FIG. 12 is a perspective view of a dispenser according to another embodiment of the present invention. The arrow shown in this figure indicates that the storage cartridge is being moved toward the dispenser portion.

FIG. 13 is a perspective view of a dispenser according to yet another embodiment of the present invention. The arrow shown in this figure indicates that the storage cartridge is being moved toward the dispenser portion.

FIG. 14A is a top view of a dispenser according to a further embodiment of the present invention.

FIG. 14B is a front view of the dispenser shown in FIG. 14A.

FIG. 15A is a cut-away top view of the rear lift mechanism shown in FIG. 14A.

FIG. 15B is a cut-away side view of the rear lift mechanism shown in FIG. 15A.

FIG. 16A is a top view of the dispenser shown in FIG. 14A.

FIG. 16B is a front view of the dispenser shown in FIG. 14A.

FIG. 17 is a front view of the dispenser shown in FIG. 14A showing the right lift handle of the right lift mechanism of FIG. 14A rotated into a substantially horizontal position. As shown, this rotation serves to lift the right end of the dispenser portion above the floor.

FIG. 18 is a right side view of the dispenser assembly of FIG. 17, wherein the right lift handle is rotated into the horizontal position.

FIG. 19 is a right side view of the dispenser assembly of FIG. 17 after the right sliding lower dispenser support has been slid into position to support the dispenser portion and the right lift handle is rotated back into the vertical position.

FIG. 20 is a front view of the dispenser shown in FIG. 14A showing the dispenser's left lift handle rotated into the horizontal position and the left sliding lower dispenser support positioned underneath the dispenser portion.

FIG. 21 is a top view of the dispenser shown in FIG. 14A showing the dispenser's top latch rotated into position to attach the top of the dispenser portion adjacent the storage cartridge.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein. Rather, these embodiments are provided so that this disclosure will satisfy applicable legal requirements. Like numbers refer to like elements throughout.

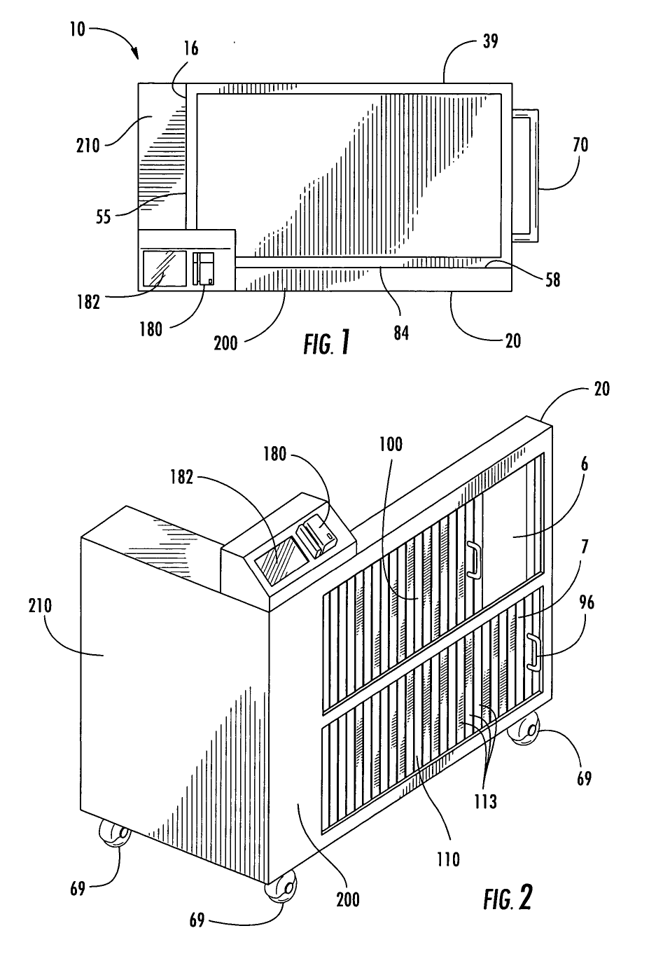

As may be understood from FIGS. 1-4, a mobile dispenser 10 according to a particular embodiment of the invention comprises a storage cartridge 39 and a dispenser portion 20. In various embodiments, the storage cartridge 39 comprises a ceiling, a floor, and three side walls that cooperate to define an interior portion that is adapted for receiving one or more articles 53 (e.g., hospital bed linens, scrubs). In one embodiment, the storage cartridge 39 is mounted adjacent a first set of one or more rolling mechanisms (e.g., wheels or roller tracks) 71 so that the storage cartridge 39 may be rolled adjacent a floor surface.

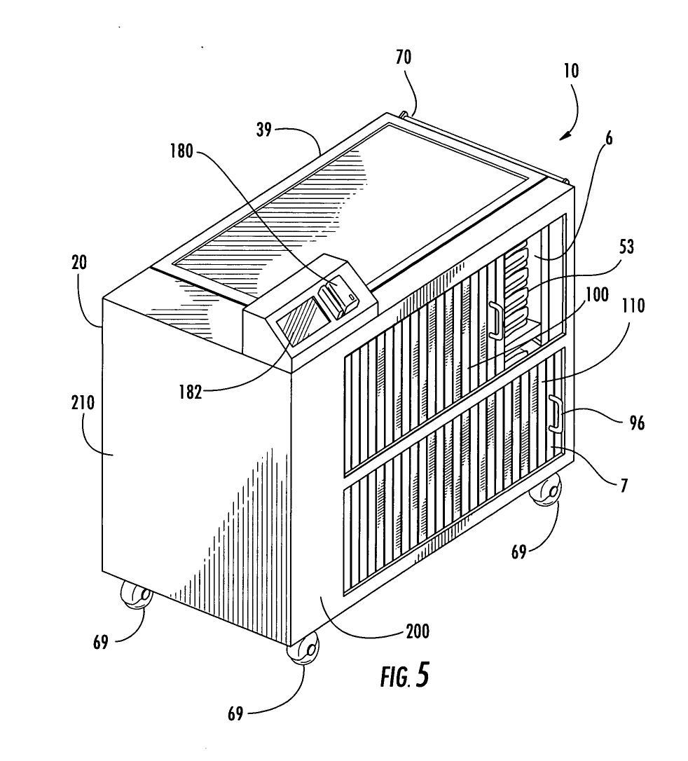

In particular embodiments of the invention, the dispenser portion 20 is adapted to be selectively attached adjacent the storage cartridge 39. The dispenser portion 20 may be mounted adjacent a second set of wheels 69 so that, like the storage cartridge 39, the dispenser portion 20 may be rolled adjacent a floor surface. Furthermore, in various embodiments, the dispenser portion 20 is adapted to selectively prevent access to one or more articles 53 when: (1) the one or more articles 53 are disposed within the interior portion of the storage cartridge 39; and (2) the dispenser portion 20 is attached adjacent to the storage cartridge 39, as shown in FIGS. 5 and 6.

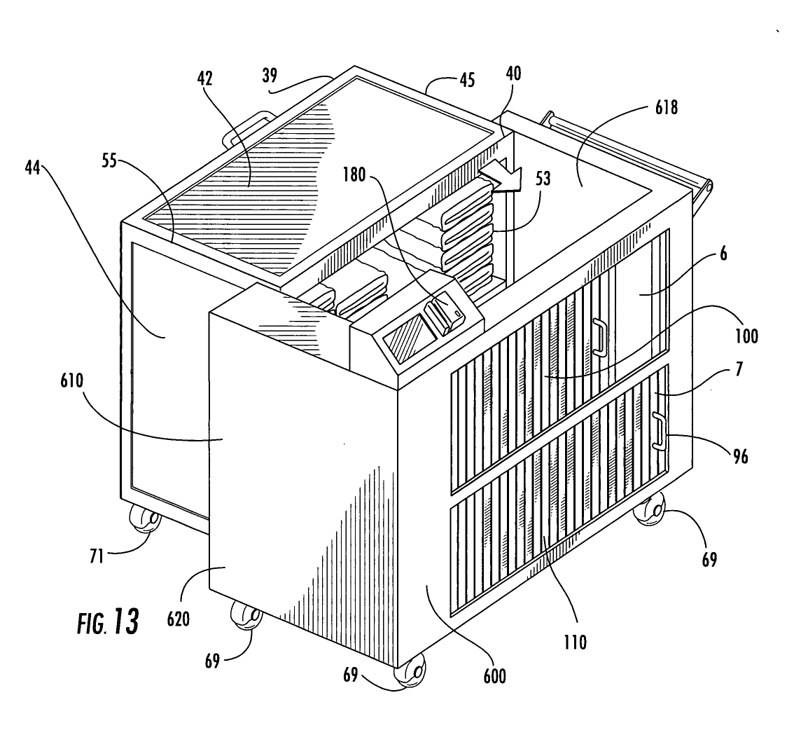

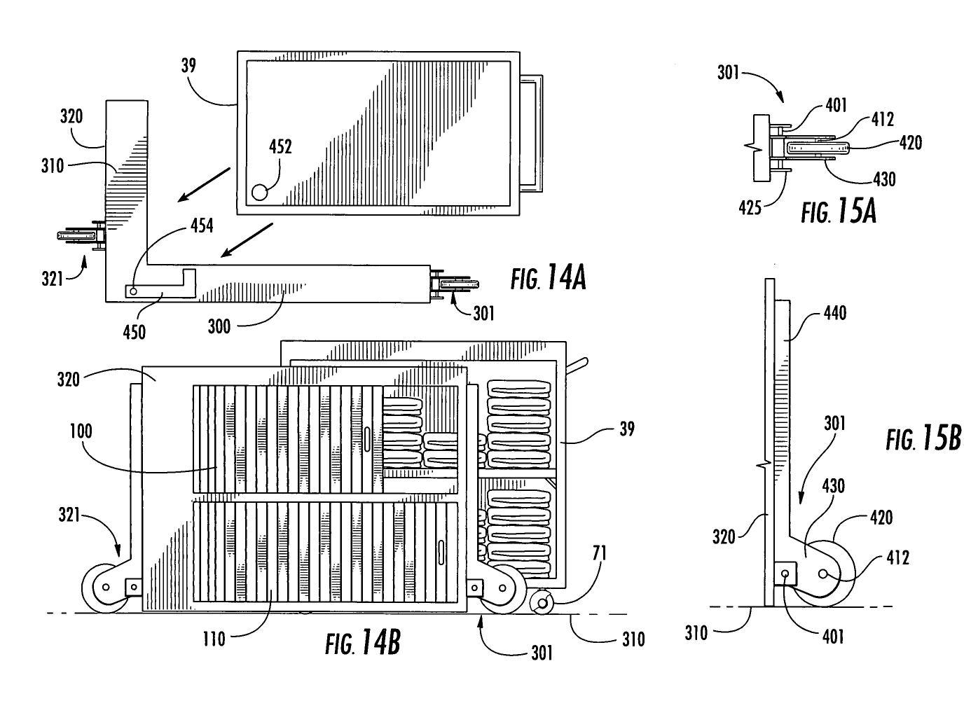

In an alternative embodiment, the mobile dispenser 10 comprises: (1) a storage cartridge 39 that is mounted to roll on a set of wheels 71; and (2) a dispenser portion 20 that is adapted to be selectively attached adjacent to the storage cartridge 39 so that the dispenser portion 20 is supported by the storage cartridge 39. (See FIGS. 14A-21). In this embodiment, when the dispenser portion 20 is attached adjacent the storage cartridge 39, the storage cartridge 39 and dispenser portion 20 are preferably both supported by the storage cartridge's wheels 71. Accordingly the storage cartridge 39 and dispenser portion 20 may be rolled as a single unit over a floor surface on the storage cartridge's wheels 71.

I. Exemplary Structure of the Mobile Dispenser

A dispenser assembly 10 according to one embodiment of the invention comprises a storage cartridge 39 and a dispenser portion 20 that are adapted to be operatively attached adjacent to one another. Exemplary embodiments of the storage cartridge 39 and the dispenser portion 20 are described in greater detail below.

Storage Cartridge

As may be understood from FIG. 3, a storage cartridge 39 according to one embodiment of the present invention is in the shape of an open-faced cart defining an interior portion that is adapted for receiving one or more items or articles. In this embodiment, the storage cartridge 39 is mounted adjacent (and preferably on) a first set of wheels so that an user may roll the storage cartridge 39 across a flooring surface from a first location to a second location.

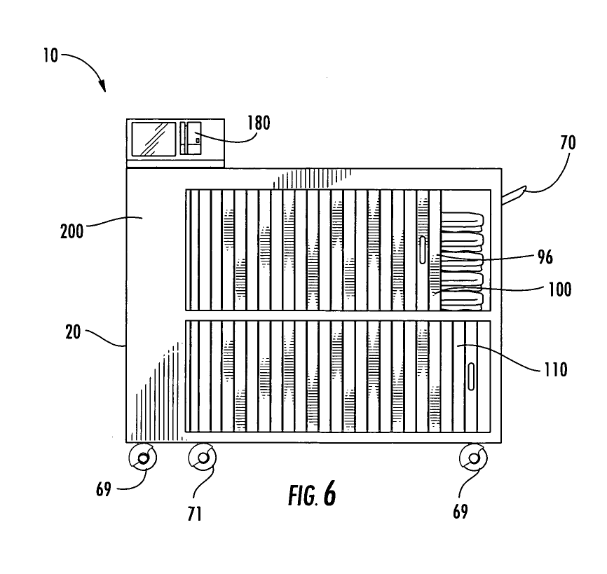

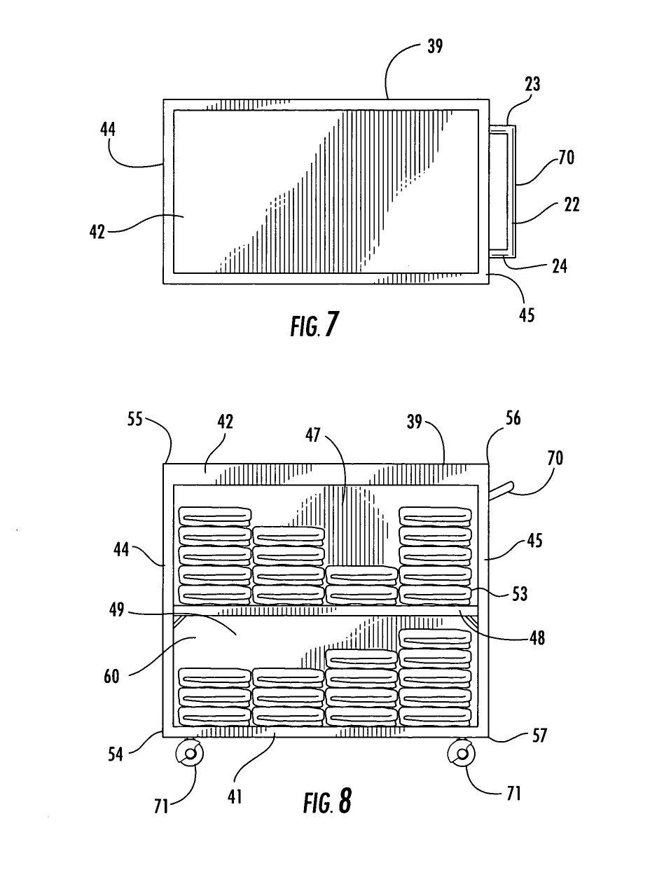

As shown in FIG. 3, a storage cartridge 39 according to one embodiment of the invention is configured for storing articles 53, such as towels or linen items, that are to be dispensed from the dispenser 10. As may be understood from FIGS. 3, 4, 7, and 8, in this embodiment, the storage cartridge 39 comprises a substantially rectangular, open faced box 40 comprising: (1) a substantially planar, substantially rectangular, and substantially horizontal floor 41; (2) a substantially planar, substantially rectangular, and substantially horizontal ceiling 42 that is parallel to and offset from the floor 41; (3) a substantially planar, substantially rectangular, and substantially vertical rear wall 60 that extends between corresponding rear edges of the storage cartridge's floor 41 and ceiling 42; (4) a first, substantially planar, substantially rectangular, and substantially vertical side wall 44 that extends between corresponding first side edges 54, 55 of the floor 41 and the ceiling 42; and (5) a second, substantially planar, substantially vertical, and substantially rectangular side wall 45 that is parallel to and offset from the first side wall 44 and that extends between corresponding second side edges 56, 57 of the floor 41 and ceiling 42 (see FIG. 8). As may be understood from FIGS. 3 and 8, the floor 41, ceiling 42, rear wall 60, and first and second side walls 44, 45 cooperate to define an interior storage portion 47 that is of suitable size to store a plurality of articles 53 to be dispensed from the dispenser assembly 10.

FIG. 8 depicts an exemplary storage cartridge 39 that includes a substantially horizontal divider member 48 that extends between the storage cartridge's first 44 and second 45 side walls. The horizontal divider member 48 serves to divide the storage cartridge 39 and to provide a surface for supporting the weight of articles 53 stored within the storage cartridge 39. The storage cartridge's ceiling 42, rear wall 60, first side wall 44, second side wall 45, and horizontal divider member 48 cooperate to define a first interior portion 47 of the storage cartridge 39. The storage cartridge's floor 41, rear wall 60, first side wall 44, second side wall 45, and horizontal divider member 48 cooperate to define a second interior portion 49 of the storage cartridge 39.

In an alternative embodiment (not shown), a series of parallel horizontal divider members extend between the storage cartridge's first and second side walls 44, 45. Much like the embodiment described above, the series of horizontal divider members are substantially parallel to and offset from one another and provide one or more surfaces for supporting the weight of articles 53 stored within the storage cartridge 39.

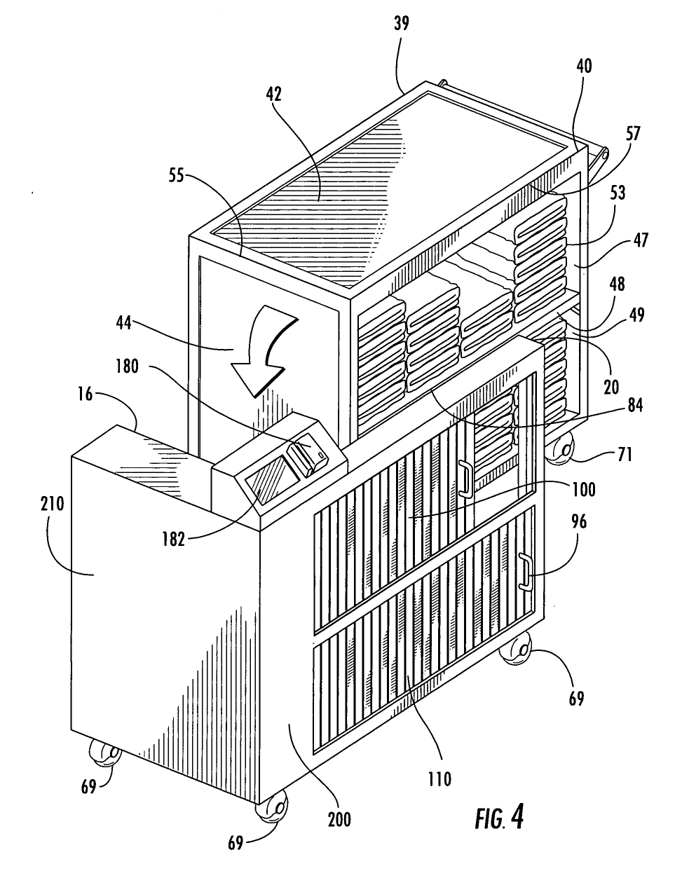

In various embodiments, the storage cartridge 39 comprises a plurality of wheels 71 or other suitable roller mechanisms (e.g., tracks) that are disposed adjacent (and preferably attached to) the exterior surface of the storage cartridge's floor 41. In certain embodiments, the wheels 71, or other conventional roller mechanisms, support the storage cartridge 39 and allow the storage cartridge 39 to be wheeled in a free range of motion. As illustrated in FIG. 4 and described in greater detail below, the wheels 71 allow a user to move the storage cartridge 39 toward the dispenser portion 20 and into position to be attached adjacent the dispenser portion 20. These wheels 71 may be configured and attached adjacent the storage cartridge 39 in any of many ways and configurations known in the art. For example, the wheels 71 may be attached adjacent the exterior surface of the storage cartridge's floor 41 using screws or other suitable fasteners. In addition, in one embodiment, the wheels 71 are attached to swivel adjacent to the storage cartridge 39.

In one embodiment of the present invention, the storage cartridge 39 is equipped with a handle 70. For example, as depicted in FIGS. 7 and 8, the handle 70 may be attached adjacent an exterior surface of the storage cartridge's second rectangular side wall 45. This handle 70 is preferably configured to allow a user to push and steer the cartridge as it is being wheeled from place to place.

The Dispenser Portion

As may be understood from FIGS. 4 and 5, in various embodiments, the dispenser portion 20 is adapted to be selectively attached adjacent the storage cartridge 39 to selectively restrict (and, preferably, to selectively prevent) access to articles 53 stored within the storage cartridge 39. In certain embodiments, the dispenser portion 20 is adapted to selectively restrict access to articles stored within the storage cartridge 39 by: (1) receiving authorization information from an user; (2) determining whether the authorization information is valid; and (3) in response to determining that the authorization information is valid, unlocking one or more access doors 100, 110 associated with the dispenser portion 20. In this embodiment, the dispenser portion 20 is preferably configured to maintain the one or more access doors 100, 110 in a locked position in response to determining that the authorization information is not valid.

For example, the dispenser portion 20 may include a card reader 180 for reading access card information, and a computer that is programmed receiving and processing access information read by, and received from, the card reader 180. In a particular embodiment, in order to access items within the storage cartridge 39, a user swipes an access card through the card reader 180, and the card reader 180 reads a user identification code that is stored on the access card. The card reader then transmits the identification code to the dispenser portion's computer for processing. In response to determining that the identification code corresponds to a valid user, the computer sends a signal to a control system associated with the dispenser portion 20 causing the control system to unlock one or more of the dispenser portion's access doors 100, 110. This allows the user to open one or more of the dispenser portion's access doors 100, 110, and to retrieve items stored within the storage cartridge 39 through one or more of the access doors 100, 110. However, in response to determining that the identification code does not correspond to a valid user, the computer and control system simply maintain the access doors 100, 110 in a locked orientation. This prevents invalid users from removing items from the dispenser 10.

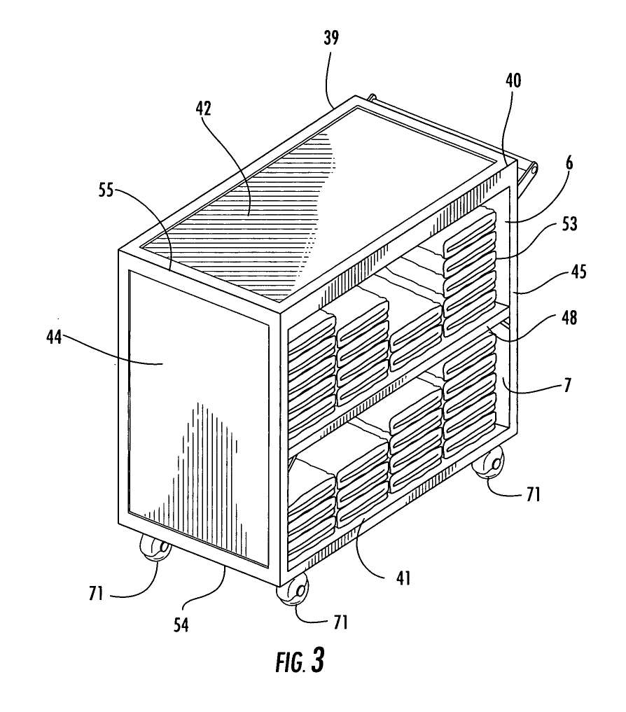

In the embodiment depicted in FIGS. 2 and 4, the dispenser portion 20 includes a substantially planar, substantially rectangular front portion 200 and a substantially planar, substantially rectangular leading side portion 210. In this embodiment, the front portion 200 and the leading side portion 210 cooperate to form a substantially L-shaped dispenser portion 20. In this embodiment, the front portion 200 includes two substantially rectangular openings 6, 7. As shown in FIGS. 2, 4, and 5, the front portion 200 also includes two access doors 100, 110. Each access door 100, 110 is dimensioned and positioned to control access to a respective discrete interior portion 47, 49 of the storage cartridge 39.

As illustrated in FIG. 4, in the embodiment shown, the rectangular openings 6, 7 have perimeters that are substantially the same size and shape as the corresponding perimeters of the interior portions of the storage cartridge 47, 49. In this embodiment, the storage cartridge 39 includes one horizontal divider member 48 so that the storage cartridge is divided into two distinct interior portions 47, 49. Thus, the corresponding dispenser portion 20 includes two substantially rectangular openings 6, 7 (see FIG. 8). In other embodiments, the storage cartridge 39 may include more than one horizontal divider member 48 and more than two interior portions.

In the embodiment illustrated in FIGS. 2 and 4, the width of the first and second horizontal openings 6, 7 is about the same as the width of the storage cartridge's front face (which is approximately the distance between the storage cartridge's first and second side walls 44, 45). Also, in this embodiment, the height of each of the storage cartridge's horizontal openings 6, 7 (see FIG. 2) is approximately the same as the height defined by either: (1) the distance between the storage cartridge's ceiling 42 and horizontal divider member 48; or (2) the distance between the storage cartridge's horizontal divider member 48 and floor 41. As mentioned above, in this embodiment, the horizontal openings 6, 7 are defined so that when the storage cartridge 39 is registered in place adjacent the dispenser portion 20, the access doors 100, 110 align, respectively, with the first and second interior portions 47, 49 of the storage cartridge 39.

In the embodiment depicted in FIG. 2, the access doors 100, 110 are mounted to slide horizontally on tracks. The tracks allow the access doors 100, 110 to move from a first, closed position to a second, open position. In this embodiment, to open a particular access door 100, 110, the user slides the door horizontally toward the leading side portion 210 of the dispenser portion 20 (see FIG. 5). As the access door 100, 110 slides horizontally to an open position, the leading end of the access door 100, 110 begins to accumulate or “roll-up” on a door support (not shown) disposed within the leading side portion 210 of the dispenser portion 20.

In one embodiment of the invention, the access doors 100, 110 comprise a series of substantially parallel slats 113 that are preferably fastened together so that they may flex along gaps defined by the co-facing sides of each adjacent pair of slats 113. FIG. 2 shows a door comprising a series of substantially vertical, substantially parallel slats 113. In this embodiment, the slats 113 are preferably connected together by two or more flexible elongate members (not shown), such as ropes or cables.

The flexible elongate members 113 are preferably attached to each slat 113 using an appropriate fastener (not shown). In one embodiment of the invention, twist tabs (not shown) are used to attach the flexible elongate members to the slats 113. The flexible elongate members serve to hold the slats 113 in place and also serve to provide a cushioned surface for the slats 113 as they roll onto the support embedded within the leading side portion 210 of the dispenser portion 20. If the door support rotates more than one revolution, the flexible elongate members (which are preferably made of a soft material) serve as a soft buffer between the various layers of slats 113 supported by the door support. This serves to reduce the noise that would otherwise occur as a result of the various slats 113 engaging each other as they are rolled onto the door support. Various examples of suitable access doors according to various embodiments of the invention are described in U.S. patent application Ser. No. 10/414,581, entitled “Reduced Friction Flexible Door”, which was filed on Oct. 21, 2004, and which is hereby incorporated by reference.

In another embodiment of the invention, the access doors 100, 110 preferably comprise a sheet of flexible material, such as fabric (e.g., ballistic nylon). In yet another embodiment of the invention, the access doors 100, 110 comprise one or more sheets of transparent material, such as clear flexible plastic. This allows users to view the contents of the storage cartridge 39 without opening the access doors 100, 110. The access doors 100, 110 may be made of any of a variety of other materials, such as any appropriate flexible metal, interlocked pieces of a rigid material, or separate, non-interlocking slats.

In another embodiment of the present invention (not shown), the access doors are attached to the front portion of the dispenser portion via one or more hinges so that each access door 100, 110 may be moved between: (1) a first position in which the access door 100, 110 substantially restricts (and preferably prevents) access to an interior portion of the storage cartridge 39; and (2) a second position in which the access door 100, 110 does not substantially restrict access to the interior portion of the storage cartridge 39. In various embodiments, the access doors 100, 110 are dimensioned to be slightly larger (e.g., vertically and/or horizontally) than the substantially rectangular openings 6, 7 of the dispenser portion 20 so as to substantially prevent access to the interior portions of the storage cartridge 39 through the openings 6, 7.

In an alternative embodiment of the invention (not shown), the front portion 200 of the dispenser portion 20 includes a single, large rectangular opening rather than a plurality of individual, rectangular openings. In this embodiment, a single, large access door is provided to restrict access to the storage cartridge 39. This embodiment functions is much the same way as the embodiment depicted in FIGS. 2 and 4. However, rather than using multiple, smaller access doors to control access to the interior of the storage cartridge 39, a single access door is used for this purpose.

In yet another alternative embodiment (not shown) of the dispenser portion 20, the dispenser portion's front portion 200 comprises one or more sliding user doors, which are, in one embodiment of the invention, arranged in a substantially vertical array. A structure of one suitable door structure is described in U.S. patent application Ser. No. 10/671,301, which was filed Sep. 24, 2003 and entitled “Automated Sliding User Doors and Door Mechanisms for a Dispenser”, and which is herby incorporated by reference it its entirety.

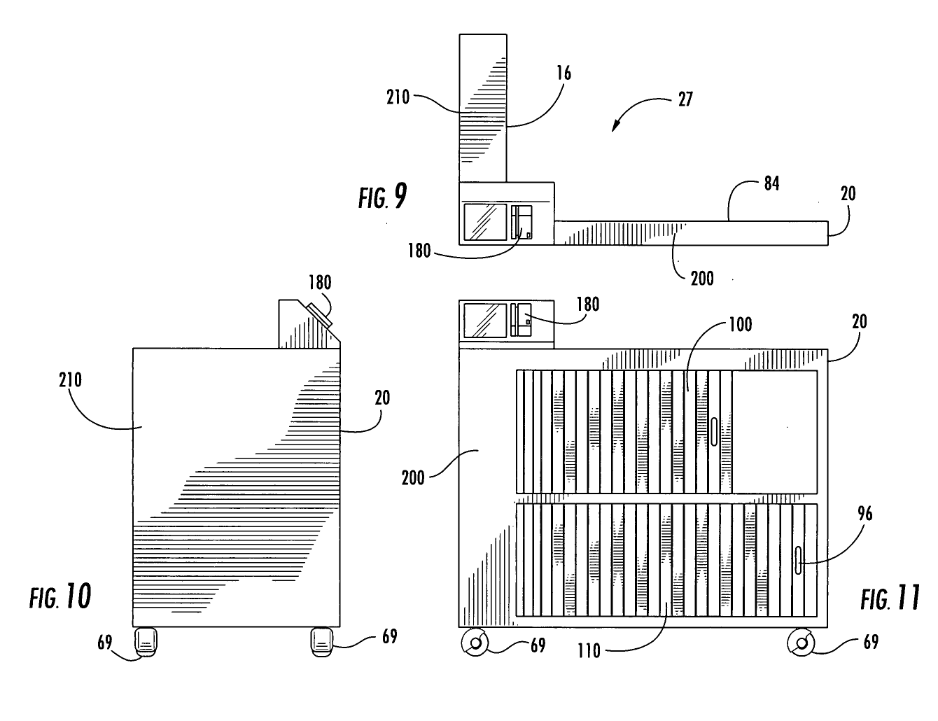

In yet another embodiment of the invention, which is depicted in FIG. 12, the dispenser portion 520 includes: (1) a substantially planar, substantially rectangular front portion 500; (2) a substantially planar, substantially rectangular leading side portion 510; and (3) a substantially planar, substantially rectangular back portion 518. In this embodiment, the front portion 500, the back portion 518, and the leading side portion 510 cooperate to form a three-sided (e.g., substantially U-shaped) dispenser portion 520. As shown in FIG. 12, in this embodiment, the dispenser portion's front portion 500 and back portion 518 are connected to opposite ends of the leading side portion 510 so that the front portion 500 and the back portion 518 are: (1) offset from each another; and (2) substantially parallel to each other. The distance, or offset, between the front portion 500 and back portion 518 is preferably greater than the length of the first side edge 55 of the storage cartridge 39. In various embodiments, the front portion 500 may include two horizontal rectangular openings 6, 7. In addition, as shown in FIG. 12, the front portion 500 includes two access doors 100, 110 that are adapted to control access to the interior portions of the storage cartridge 47, 49 in the manner discussed above.

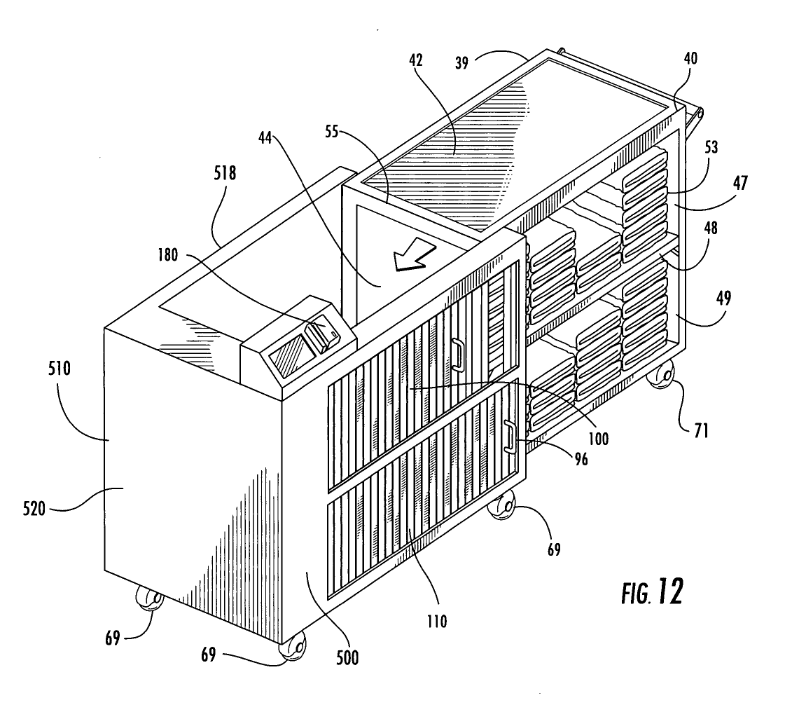

A further embodiment of the invention is shown in FIG. 13. In this embodiment, the dispenser portion 20 includes a substantially planar, substantially rectangular front portion 600, a substantially planar, substantially rectangular leading side portion 610, and a substantially planar, substantially rectangular trailing side portion 618. In this embodiment, the front portion 600, the trailing side portion 618, and the leading side portion 610 cooperate to form a substantially U-shaped dispenser portion 620 that comprises three walls. As shown in FIG. 13, the leading side portion 610 and trailing side portion 618 are connected to the front portion 600 so that the leading side portion 610 and trailing side portion 618 are offset from one another and substantially parallel to each other. The distance, or offset, between the leading side portion 620 and trailing side portion 618 is preferably greater than the distance between the first 44 and second 45 side walls of the storage cartridge 39. In this embodiment, the front portion 600 includes two horizontal rectangular openings 6, 7. In addition, as shown in FIG. 13, the front portion 600 includes two access doors 100, 110 that are dimensioned to control access to the interior portions of the storage cartridge 47, 49 in the manner discussed above.

The Control System

In the embodiment illustrated in FIG. 1, the dispenser portion 20 includes a computerized control system (not shown) for controlling access to the first and second interior storage portions 47, 49 of the storage cartridge 39. In this embodiment, the control system includes a card reader 180 that is adapted to read information from various users' access cards, a user interface 182 (e.g., a touch-screen display) that is configured to perform a variety of functions such as processing requests for particular items, and a control mechanism for locking and unlocking the dispenser's first and second access doors 100, 110. Furthermore, one embodiment of the control system includes a computer processor that is operative to: (1) obtain user information from the card reader 180; (2) display information to, and receive information from, the user interface 182; (3) send signals to the control mechanism causing the control mechanism to unlock one or more of the various access doors 100, 110; and (4) send signals to the control mechanism causing the control mechanism to relock a particular access door 100, 110 after an article is removed and the particular access door 100, 110 has been closed.

II. Operation of Various Embodiments

To use a dispenser assembly 10 according to various embodiments of the invention, an user at a central cartridge loading facility first loads an empty storage cartridge 39 with one or more articles 53. (See FIG. 3). After loading the storage cartridge 39, the user registers the storage cartridge 39 in place adjacent the dispenser portion 20 by wheeling the storage cartridge 39 toward the dispenser portion 20 (see FIG. 4) and positioning the storage cartridge 39 so that: (1) the storage cartridge's first side edge 55 abuts and aligns with the inner side portion 16 of the dispenser portion's leading side portion 210; and (2) the storage cartridge's second side edge 57 abuts and aligns with the inner edge 84 of the dispenser portion's front portion 200. (See FIGS. 1 and 4).

In various embodiments, after the user aligns the storage cartridge 39 and dispenser portion 20 as shown in FIG. 1, a locking mechanism (not shown) is moved (e.g., by the user or by the dispenser assembly's control system) from a first “unlocked” position to a second “locked” position to secure the storage cartridge 39 adjacent the dispenser portion 20. When the storage cartridge 39 is properly secured adjacent the dispenser portion 20, the dispenser portion's first and second access doors 100, 110 are preferably substantially aligned with the first and second interior portions 47, 49 of the storage cartridge 39. In addition, as shown in FIG. 5, when the storage cartridge 39 is properly secured adjacent the dispenser portion 20, the storage cartridge 39 and dispenser portion 20 cooperate to form a dispenser assembly 10 having a three dimensional, substantially rectangular shape.

After the storage cartridge 39 and the dispenser portion 20 are secured together, the dispenser portion's access doors 100, 110 are locked closed. This prevents unauthorized users from accessing items within the storage cartridge 39.

Because, in various embodiments, both the storage cartridge 39 and the dispenser portion 20 are equipped with wheels 69, 71 or other suitable roller mechanisms, the user can roll the combined dispenser assembly 10 from place to place over a floor surface. When the user reaches a first destination location (e.g., a patient's room), the user may want to remove an article 53 (e.g., a set of bed linens) from the storage cartridge 39. In order to do so, the user must first gain access to the interior of the storage cartridge 39. In one embodiment of the invention, the user gains access to the interior of the storage cartridge 39 by conveying user-access information (such as an access code or an employee ID number) to the dispenser portion's control system.

In various embodiments of the invention, the user conveys user-access information to the dispenser portion's control system by swiping a standard identification card through a card reader 180 that is in electronic communication with the dispenser portion's control system. In this embodiment, the card reader 180 reads user-access information from the card (e.g., in any suitable manner known in the art), and then conveys the user-access information to the control system. The control system then determines whether to allow the user to access the interior of the storage cartridge 39. For example, the control system may search a database of valid users to determine whether an employee ID number conveyed within the user-access information corresponds to a valid user. In one embodiment, if the employee ID number does not correspond to a valid user, the control system denies the user access to the interior of the storage cartridge 39 (e.g., by maintaining the dispenser portion's access doors 100, 110 in a locked configuration) and informs the user (e.g., via a text message displayed on the dispenser portion's user interface 182) that the user does not have permission to access items within the storage cartridge 39. If the control system determines that the user should be permitted access items within the dispenser, the dispenser's control system automatically unlocks one or both of the dispenser's access doors 100, 110.

Once the dispenser's access doors 100, 110 are unlocked, the user moves a particular access door 100, 110 from a closed position to an open position. As shown in FIG. 5, in various embodiments, when the particular access door 100 is in open position, the user can reach through a substantially rectangular opening 6 defined by the dispenser portion 20 to remove one or more articles 53 stored on top of the storage cartridge's horizontal divider member 48. Once the user has finished removing one or more of the articles 53, the user moves the access door 100 back into the closed position. In one embodiment, the access door 100 will automatically lock in response to being moved into the first closed position.

In an alternative embodiment, the access doors 100, 110 do not automatically unlock in response to the control system granting the user access. Instead, in this embodiment, the user manually unlocks one or both access doors 100, 110 by entering commands into the dispenser's user interface 182. For example, in one embodiment, once the dispenser's computer determines that the user should be permitted access to the dispenser's interior, the user interface 182 displays a touch-sensitive access button (not shown) that, when pressed, causes the dispenser's control system to unlock one or more of the dispenser's access doors 100, 110.

In an alternative embodiment (not shown), the dispenser portion 20 is not equipped with a control system. Instead, each access door is equipped with a traditional mechanical locking apparatus. In this embodiment, the user uses a key to lock and unlock each access door 100, 110.

In an alternative embodiment in which the dispenser portion 20 is equipped with a control system, the user interface 182 allows the user to keep track of when and where each article was dispensed. For example, in various embodiments, by using a soft keypad (not shown) displayed within the user interface 182, the user may record information associated with each article's distribution, such as the location and time at which the article was distributed to a particular user.

When the user has finished distributing articles 53, (e.g., when the storage cartridge 39 is empty) the user typically wheels the dispenser 10 to a designated area and detaches the dispenser's storage cartridge 39 from the dispenser portion 20. The user then wheels the storage cartridge 39 to a central loading area to be refilled. In the meantime, another user may wheel another, loaded storage cartridge 39 to the designated area, attach the loaded storage cartridge 39 to the dispenser portion 20, and then use the resulting dispenser 10 to securely dispense articles from the dispenser 10 as described above.

### Alternative Embodiments

FIGS. 14A-17 depict alternative embodiments in which the mobile dispenser 10 includes: (1) a storage cartridge 39 containing articles or items to be dispensed; and (2) a separate dispenser portion 320 that may be selectively attached adjacent (and preferably to) the storage cartridge 39, and that is configured to selectively restrict access to items within the storage cartridge 39.

Much like the embodiment shown in FIG. 2, the dispenser portion 320 shown in FIGS. 14A and 14B comprises a substantially planar, substantially rectangular front portion 300, a substantially planar, substantially rectangular leading side portion 310, a first access door 100, and a second access door 110. In this embodiment, the dispenser portion 320 is adapted to be selectively registered with the storage cartridge 39 so that wheels attached adjacent to the storage cartridge 39 may be used to move the storage cartridge 39 and dispenser portion 320 from place to place.

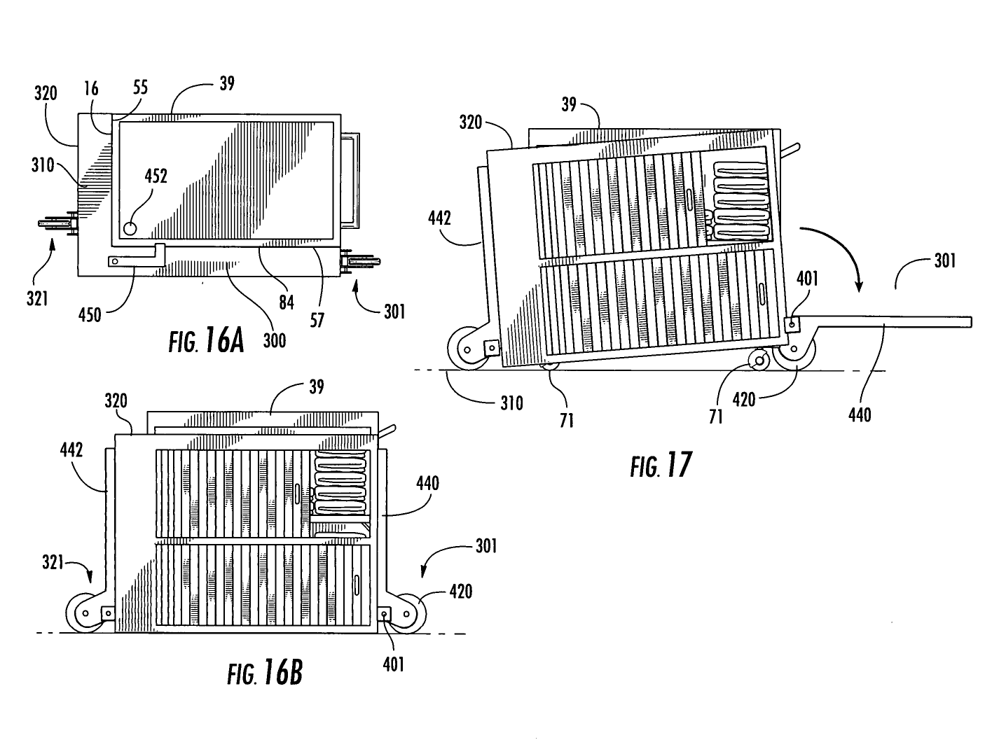

To register the dispenser portion 320 adjacent the storage cartridge 39, an user rolls the storage cartridge 39 toward the dispenser portion 320, as shown by the arrows in FIG. 14A. Referring now to FIG. 16A, the user then positions the storage cartridge 39 so that: (1) the storage cartridge's first side edge 55 abuts and aligns with the inner side portion 16 of the dispenser portion's leading side portion 310: and (2) the storage cartridge's second side edge 57 abuts and aligns with the inner edge 84 of the dispenser portion's front portion 300. When the storage cartridge 39 abuts the dispenser portion 320, as shown in FIG. 16A, the user utilizes the dispenser's right and left lift mechanisms 301, 321 to lift the dispenser portion 320 into alignment with the storage cartridge 39.

FIGS. 15A and 15B depict one embodiment of the right lift mechanism 301, which is shown attached adjacent the dispenser portion 320 in FIGS. 14A and 14B. As shown in FIGS. 15A and 15B, in various embodiments, the right lift mechanism 301 includes a handle 440 (“the right handle”), a wheel 420, a wheel axle 412, a pivot axel 401, a pivot bracket 425, and a wheel support blade 430. As shown in FIG. 15B, the right lift mechanism 301 is attached adjacent the dispenser portion 320 via the pivot bracket 425, which is located approximately 3 to 4 inches from the floor 310 in this particular embodiment. The wheel support blade 430 is disposed within the pivot bracket 425 and connected to the dispenser at the pivot axle 401. As shown in FIG. 15A, the wheel 420 is attached to the wheel support blade 430 at the wheel axle 412, and the wheel 420 is disposed within the wheel support blade 430.

In FIG. 15B, the right lift mechanism 301 is shown in a first position in which the wheel 420 and the bottom of the dispenser portion 320 lie in substantially the same plane. In this first position, the right handle 440 extends substantially vertically from the wheel support blade 430 and runs substantially parallel to the trailing side of the dispenser portion 320. As mentioned above, once the storage cartridge 39 is registered adjacent the dispenser portion 320 as shown in FIGS. 16A and 16B, the user rotates the right handle 440 about the pivot axle 401 until the right handle 440 is in substantially horizontal position, as shown in FIG. 17. This rotation causes right lift mechanism's wheel 420 to contact the floor 310, which lifts a first side of the dispenser portion 320 above the floor as shown in FIG. 17.

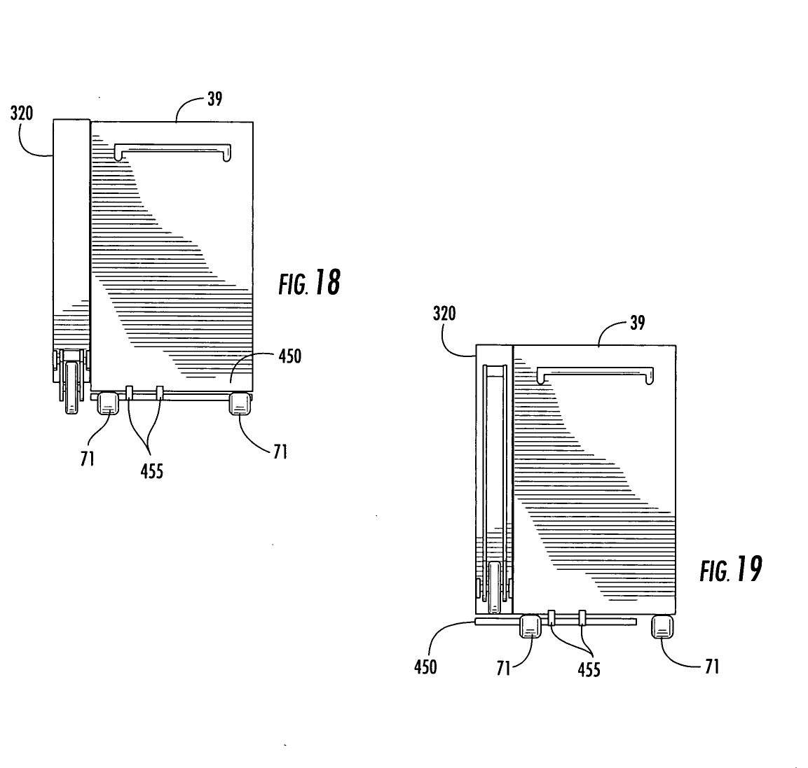

Referring now to FIG. 18, when the right handle 440 is in the substantially horizontal position, the bottom of the lifted right side of the dispenser portion 320 and the bottom of the storage cartridge 39 are positioned in substantially the same horizontal plane, which is approximately 3 inches above the floor. With the handle 440 remaining in the substantially horizontal position, the user then slides a right sliding lower dispenser support 450 outwardly from the storage cartridge 39, as shown in FIG. 19. (This sliding lower dispenser support 450 may be, for example, a metal plate that is mounted to slide substantially horizontally adjacent the bottom portion of the storage cartridge's floor.)

Once the right sliding lower dispenser support 450 is positioned underneath the dispenser portion 320, the user rotates the right handle 440 to return this handle 440 to the first, substantially vertical position. Moving the handle 440 from the second (substantially horizontal) position to the first (substantially vertical) position lowers the dispenser portion 320 onto the right sliding lower dispenser support 450.

The right sliding lower dispenser support 450 is configured to hold the dispenser portion 320 in substantially the same horizontal plane as the bottom of the storage cartridge 39 (e.g., which is approximately three inches above the ground in one embodiment). As shown in FIGS. 18 and 19, the right sliding lower dispenser support 450 may be held in position underneath the bottom of the storage cartridge 39 via a pair of support loops 455.

Returning to FIG. 17, the user then proceeds to the opposite side of the dispenser portion 320 (i.e., the side that remains on the floor) and rotates the left lift mechanism's handle 442 (the “left handle”) from a substantially vertical position to a substantially horizontal position, as shown in FIG. 20. This rotation raises the left side of the dispenser portion 320 to a level that is substantially even with the right side of the dispenser portion 320, as shown in FIG. 20. As may be understood from FIG. 20, in this embodiment, when the left handle 442 is in the second substantially horizontal position, the bottom of the dispenser portion 320 lies in substantially the same horizontal plane as the bottom of the storage cartridge 39.

The user then slides a left sliding lower dispenser support 452 out from under the storage cartridge 39 until the left sliding lower dispenser support 452 is substantially underneath the entire width of the dispenser assembly 320. (In various embodiments of the invention, the left sliding lower dispenser support 452 has substantially the same structure and functionality as the right sliding lower dispenser support 450 described above.) Once the left sliding lower dispenser support 452 is disposed underneath a substantial portion of the dispenser assembly 320, the user moves the left handle 442 back to the first (substantially vertical) position. As this handle 442 is moved back to the first position, the dispenser portion's left side is lowered onto the left sliding lower dispenser support 452. As with the right sliding lower dispenser support 450, the left sliding lower dispenser support 452 is held in position underneath the bottom of the storage cartridge 39 using a pair of support loops (not shown).

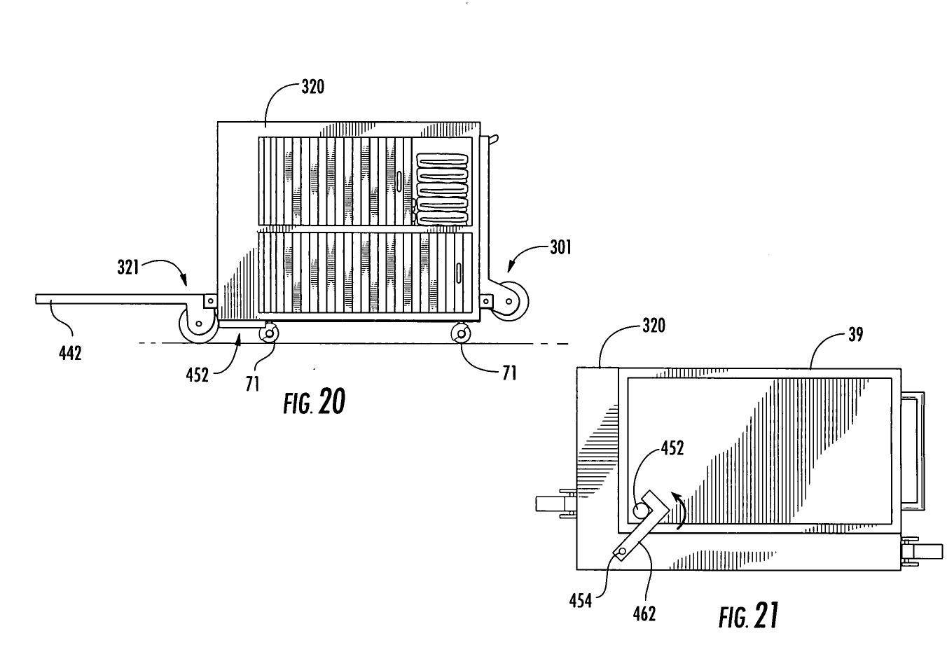

In one embodiment, once both sides of the dispenser portion 320 are supported by the storage cartridge's left and right sliding lower dispenser supports 450, 452, the user secures the storage cartridge 39 to the dispenser portion 320 using a top latch 462, located on top of the dispenser portion 320 (see FIG. 21). As shown in FIG. 21, the top latch 462 is rotated about a pivot 454 to cause the top latch 462 to engage a pin 452 on the top surface of the storage cartridge 39. The movement of the top latch 462 is shown by the arrow in FIG. 21. After the dispenser portion 320 is secured adjacent the storage cartridge 39, the mobile dispenser assembly 10 may be rolled across a floor surface on wheels 71 that are attached adjacent the bottom of the storage cartridge 39.

It should be noted that other types of latches may be used to attach the dispenser portion 320 to the storage cartridge 39. Such latches preferably prevent the dispenser portion 320 from falling off the storage cartridge 39 during movement. In addition, locks may be added to these latches to prevent unauthorized individuals from removing the dispenser portion 320 from the storage cartridge 39.

III. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mobile dispenser comprising:
a storage cartridge defining an interior portion that is adapted for receiving one or more items to be dispensed from said mobile dispenser, said storage cartridge being mounted adjacent a first set of one or more rolling mechanisms so that said storage cartridge may be rolled adjacent a support surface; and
a dispenser portion that is adapted to be selectively attached adjacent said storage cartridge, said dispenser portion being mounted adjacent a second set of one or more rolling mechanisms so that said dispenser portion may be rolled adjacent said support surface, wherein:
said dispenser portion is adapted to selectively prevent access to said one or more items when: (A) said one or more items are disposed within said interior portion; and (B) said dispenser portion is attached adjacent said storage cartridge.

2. The mobile dispenser of claim 1, wherein:
said dispenser portion comprises a door portion that is configured to selectively prevent access to said one or more items through an access opening defined by said dispenser portion when: (A) said one or more items are disposed within said interior portion; and (B) said dispenser portion is attached adjacent said storage cartridge; and
said dispenser portion is adapted to selectively prevent access to said one or more items by:
(A) receiving authorization information from a user;
(B) determining whether said authorization information is valid;
(C) in response to determining that said authorization information is valid, unlocking said door portion to permit access to said one or more items through said access opening; and
(D) in response to determining that said authorization is not valid, maintaining said door portion in a locked configuration so that said door portion prevents access to said one or more items through said access opening.

3. The mobile dispenser of claim 2, wherein said mobile dispenser is adapted to unlock said door portion automatically in response to determining that said authorization information is valid.

4. The mobile dispenser of claim 2, wherein:
said mobile dispenser comprises a memory; and
said mobile dispenser is configured to store, in said memory, a record of items stored within said storage portion.

5. The mobile dispenser of claim 4, wherein:
said mobile dispenser is adapted to modify said record of items in response to at least one of said one or more items being removed from said mobile dispenser.

6. The mobile dispenser of claim 1, wherein:
said first set of one or more rolling mechanisms comprises a plurality of wheels.

7. The mobile dispenser of claim 6, wherein:
said second set of one or more rolling mechanisms comprises a plurality of wheels.

8. The mobile dispenser of claim 1, wherein said storage cartridge and said dispenser portion are adapted so that, when said dispenser portion is attached adjacent said storage cartridge, said storage cartridge and said dispenser portion cooperate to form a wheeled cart that is adapted to be rolled over said support surface from a first location to a second location.

9. The mobile dispenser of claim 1, wherein:
said storage cartridge defines an open front face through which said one or more items may be accessed; and
said dispenser portion is adapted to selectively prevent access to said one or more items through said open front face.

10. The mobile dispenser of claim 1, wherein:
said dispenser portion defines a recess; and
at least a portion of said storage cartridge is dimensioned to be substantially matingly received within said recess.

11. The mobile dispenser of claim 10, wherein said dispenser portion is substantially L-shaped.

12. A mobile dispenser comprising:
a storage cartridge defining an interior portion that is adapted for receiving one or more items to be dispensed from said mobile dispenser, said storage cartridge being mounted adjacent a first set of one or more rolling mechanisms so that said storage cartridge may be rolled adjacent a support surface; and
a dispenser portion that is adapted to be selectively attached adjacent said storage cartridge to form a mobile dispensing apparatus, wherein:
when said dispenser portion is attached adjacent said storage cartridge to form said mobile dispensing apparatus:
(A) said dispenser portion is supported by said storage cartridge, and
(B) both said storage cartridge and said dispenser portion are rollably supported by said one or more rolling mechanisms.

13. The mobile dispenser of claim 12, wherein:
said dispenser portion comprises a door portion that is configured to selectively prevent access to said one or more items through an access opening defined by said dispenser portion when: (A) said one or more items are disposed within said interior portion; and (B) said dispenser portion is attached adjacent said storage cartridge; and
said dispenser portion is adapted to selectively prevent access to said one or more items by:
(A) receiving authorization information from a user;
(B) determining whether said authorization information is valid;
(C) in response to determining that said authorization information is valid, unlocking said door portion to permit access to said one or more items through said access opening; and
(D) in response to determining that said authorization is invalid, maintaining said door portion in a locked configuration so that said door portion prevents access to said one or more items through said access opening.

14. The mobile dispenser of claim 13, wherein said mobile dispenser is adapted to unlock said door portion automatically in response to determining that said authorization information is valid.

15. The mobile dispenser of claim 12, wherein:
said mobile dispenser comprises a memory; and
said mobile dispenser is configured to store, in said memory, a record of items stored within said storage portion.

16. The mobile dispenser of claim 15, wherein:
said mobile dispenser is adapted to modify said record of items in response to at least one of said one or more items being removed from said mobile dispenser.

17. A method of dispensing items, said method comprising:
(A) providing a wheeled cart defining an interior portion that is dimensioned for receiving one or more items to be dispensed from said wheeled cart;
(B) providing a wheeled, automated dispenser portion that is adapted:
(1) to be attached adjacent said wheeled cart, and
(2) to selectively prevent access to said interior portion when said automated dispenser portion is attached adjacent said wheeled cart;
(C) attaching said automated dispenser portion adjacent said wheeled cart; and
(D) using said automated dispenser portion to selectively prevent access to one or more items stored within said interior portion of said wheeled cart.

18. The method of dispensing items of claim 17, wherein:
said automated dispenser portion comprises a door portion that is configured to selectively prevent access to said one or more items through an access opening defined by said automated dispenser portion when: (A) said one or more items are disposed within said interior portion of said wheeled cart; and (B) said dispenser portion is attached adjacent said storage cartridge; and
said dispenser portion is adapted to selectively prevent access to said one or more items by:
(A) receiving authorization information from a user;
(B) determining whether said authorization information is valid;
(C) in response to determining that said authorization information is valid, unlocking said door portion to permit access to said one or more items through said access opening; and
(D) in response to determining that said authorization is invalid, maintaining said door portion in a locked configuration so that said door portion prevents access to said one or more items through said access opening.

19. The mobile dispenser of claim 17, wherein said automated dispenser portion is adapted to unlock said door portion automatically in response to determining that said authorization information is valid.

20. The mobile dispenser of claim 19, wherein:
said automated dispenser portion comprises a memory; and
said automated dispenser portion is configured to store, in said memory, a record of items stored within said interior portion of said wheeled cart.

21. The mobile dispenser of claim 17, wherein said storage cartridge and said automated dispenser portion are adapted so that, when said automated dispenser portion is attached adjacent said storage cartridge, said storage cartridge and said automated dispenser portion cooperate to form a wheeled cart that is adapted to be rolled over a support surface from a first location to a second location.
